(19) United States
(12) Patent Application Publication
(10) Pub. No.: US 2026/0083994 A1
(43) Pub. Date: Mar. 26, 2026

(54) FIRE EXTINGUISHING LIQUID

(71) Applicant: LIFESAFE TECHNOLOGIES LIMITED, Essex (GB)

(72) Inventor: Gavin CORNELIUS, Essex (GB)

(21) Appl. No.: 19/111,979

(22) PCT Filed: Sep. 14, 2023
(86) PCT No.: PCT/EP2023/075342

§ 371 Date: Mar. 14, 2025

(30) Foreign Application Priority Data
Sep. 15, 2022 (GB) 2213578.4

(51) Int. Cl. A62D 1/00; A62D 1/02

(52) U.S. Cl. CPC A62D 1/0035; A62D 1/0071

(57) ABSTRACT

A fire extinguishing liquid is described which includes one or more of a phosphate, hydrogen phosphate or dihydrogen phosphate salt; and a sulphate salt. The fire extinguishing liquid contains no, or substantially no, hydrogen carbonate salts. The liquid finds use in the extinguishment of fires, including battery fires.

### RELATED APPLICATIONS

This application claims the priority of UK patent application GB 2213578.4 filed on 15 Sep. 2022, the contents of which are incorporated by reference herein in their entirety.

### TECHNICAL FIELD OF THE INVENTION

The present invention relates to fire extinguishing liquids, methods of manufacturing fire extinguishing liquids, and fire extinguishers containing those liquids.

### BACKGROUND TO THE INVENTION

Some fire extinguishers are filled with liquid, herein referred to as ‘fire extinguishing liquid’. There are a number of properties which are desirable for the fire extinguishing liquid. Firstly, it must be effective at suppressing and extinguishing fires. This can be achieved in a number of ways, which are discussed in detail in the “Summary of the Invention” section below. The components contained in the fire extinguishing liquid are selected to maximize its effectiveness.

It is desirable for fire extinguishing liquids to be effective over a wide range of temperatures. However, particularly in cold climates, the types of fire extinguisher which can be used are restricted. This is because the fire extinguishing liquid is often stored in pressurized containers, and there are safety risks associated with the liquid freezing. In addition to the safety risks, the low temperature can cause (a) freezing of the fire extinguishing liquid and (b) dissolved components in the liquid to come out of solution. Solid particulate matter inside the fire extinguisher can lead to undesirable consequences such as clogging of the nozzle.

Furthermore, there is a need for further fire extinguishing liquids which are effective against a range of different types of fire. Different types of fire according to the European standard EN3 include Class A (fires involving organic solids, e.g. wood, paper), Class B (fires involving flammable liquids), Class C (fires involving flammable gases) and Class F (fires involving cooking oil and fat). It is rare for a given fire extinguishing liquid to be effective against multiple fire types.

WO 2021/078381 describes a fire extinguishing liquid containing a number of different salts in a liquid vehicle. There is a need for further fire extinguishing liquids which solve the above-mentioned problems while being economical and efficient to manufacture.

Furthermore, it would be desirable to provide effective fire extinguishing liquids which require reduced quantities of starting materials while maintaining their effectiveness against the range of fire types mentioned above.

### SUMMARY OF THE INVENTION

Broadly speaking, the present invention provides a fire extinguishing liquid which demonstrates an improved ability to extinguish fires quickly and safely relative to known compositions and is effective against a range of fire types. The fire extinguishing liquid requires lower amounts of salt, making transport of the product more economical, and is cost-effective to manufacture. In order to achieve this, a first aspect of the present invention provides a fire extinguishing liquid comprising:
(a) one or more of a phosphate, hydrogen phosphate or dihydrogen phosphate salt; and
(b) a sulphate salt;
   wherein the fire extinguishing liquid contains no, or substantially no, hydrogen carbonate salts.

The inventors have found that such a fire extinguishing liquid meets European standards for extinguishing at least fire types A and F. The liquid is therefore more versatile than many existing fire extinguishing liquids.

Furthermore, it was surprisingly found that by ensuring the absence or substantial absence of hydrogen carbonate salts, the amount of salt used per litre of liquid was reduced without jeopardising the performance of the fire extinguishing liquid. Since the amount of salt is lower and a reduced weight of ingredients is necessary to manufacture each litre of liquid, the economy of both manufacture and transport of the liquid are improved.

It has also been found that the fire extinguishing liquid is effective in the extinguishment of lithium ion battery fires, being able to quickly and safely extinguish fires which originate in various battery sizes.

A second aspect of the invention is a fire extinguishing liquid comprising:
(a) one or more of a phosphate, hydrogen phosphate or dihydrogen phosphate salt, wherein the total amount of phosphate, hydrogen phosphate and dihydrogen phosphate salt is from 20 to 25 wt %, based on the total weight of the fire extinguishing liquid; and
(b) a sulphate salt, wherein the total amount of sulphate salt is from 2 to 3 wt %, based on the total weight of the fire extinguishing liquid.

It was found that the use of phosphate salt and sulphate salt in these amounts provides a fire extinguishing liquid which is effective against a range of types of fire and straightforward to manufacture. The reduced quantities of phosphates and sulphates relative to known liquids reduces the cost of manufacture, without jeopardising the performance of the fire extinguishing liquid.

### First and Second Aspects of the Invention

The following preferences apply to both the first and second aspects of the invention.

Herein, phosphate, hydrogen phosphate and dihydrogen phosphate salts are salts including the anions PO₄³⁻, HPO₄²⁻ and H₂PO₄⁻ respectively.

A hydrogen carbonate salt is a salt including the anion HCO₃⁻.

A sulphate salt is a salt including the anion SO₄²⁻.

Preferably, the salts present in the fire extinguishing liquid are each water-soluble. In some embodiments, each of the salts has a solubility in distilled water at 20° C. of at least 5 g/100 mL, for example at least 6 g/100 mL, for example at least 10 g/100 mL, for example at least 15 g/100 mL, for example at least 20 g/100 mL.

The counter-ion to the above-mentioned anions may be selected from any suitable cation which combines with the anion to form a salt having the above solubility. Non-limiting examples of cations are alkali metal ions, alkaline earth metal ions, transition metal ions and organic cations such as ammonium ion (NH₄⁺) or primary, secondary, tertiary or quaternary ammonium cations (NH₃R⁺; NH₂R₂⁺; NHR₃⁺ or NR₄⁺ respectively, wherein each R is independently selected from C₁₋₄ saturated alkyl groups). Preferably, the counter cation is selected from alkali metal ions, alkaline earth metal ions and ammonium ion (NH₄⁺).

In some embodiments, the phosphate salt is selected from trisodium phosphate (Na₃PO₄) and tripotassium phosphate (K₃PO₄).

In some embodiments, the hydrogen phosphate salt is selected from disodium phosphate (Na₂HPO₄), dipotassium phosphate (K₂HPO₄) and diammonium hydrogen phosphate ((NH₄)₂HPO₄). In some embodiments, the hydrogen phosphate salt is diammonium hydrogen phosphate ((NH₄)₂HPO₄).

In some embodiments, the dihydrogen phosphate salt is selected from monosodium phosphate (NaH₂PO₄), monopotassium phosphate (KH₂PO₄) and monoammonium phosphate ((NH₄)H₂PO₄).

In some embodiments, the hydrogen carbonate salt is selected from sodium hydrogen carbonate (NaHCO₃), potassium hydrogen carbonate (KHCO₃) and ammonium hydrogen carbonate ((NH₄)HCO₃). In some embodiments, the hydrogen carbonate salt is ammonium hydrogen carbonate ((NH₄)HCO₃).

The fire extinguishing liquid of the first aspect contains no, or substantially no, hydrogen carbonate salts. Hydrogen carbonate salts are any salts including the anion HCO₃. Thus the fire extinguishing liquid of the first aspect contains no, or substantially no, HCO₃; anions. The term “substantially no hydrogen carbonate salts” means that hydrogen carbonate salts are present in an amount of less than 100 ppm (by weight), for example less than 50 ppm, less than 10 ppm or less than 5 ppm. Examples of such hydrogen carbonate salts are sodium hydrogen carbonate (NaHCO₃), potassium hydrogen carbonate (KHCO₃) and ammonium hydrogen carbonate ((NH₄)HCO₃).

In some embodiments, the second aspect of the invention is a fire extinguishing liquid comprising:
(a) one or more of a phosphate, hydrogen phosphate or dihydrogen phosphate salt, wherein the total amount of phosphate, hydrogen phosphate and dihydrogen phosphate salt is from 20 to 25 wt %, based on the total weight of the fire extinguishing liquid; and
(b) a sulphate salt, wherein the total amount of phosphate, hydrogen phosphate and dihydrogen phosphate salt is from 2 to 3 wt %, based on the total weight of the fire extinguishing liquid; and
(c) a hydrogen carbonate salt.

In some embodiments, the sulphate salt is selected from sodium sulphate (Na₂SO₄), potassium sulphate (K₂SO₄) and ammonium sulphate ((NH₄)₂SO₄). In some embodiments, the sulphate salt is ammonium sulphate ((NH₄)₂SO₄).

In some embodiments, component (a) is a hydrogen phosphate salt, i.e. a salt including the anion HPO₄²⁻.

Particularly good fire extinguishing properties are observed for the fire extinguishing liquid when the salts in components (a), (b) and (c) are each ammonium salts. Without wishing to be bound by theory, it is believed that this may be at least partly due to the increased quantity of ammonia produced through thermal decomposition of ammonium salts, which has a suffocating effect on the fire.

Thus in some embodiments, the fire extinguishing liquid comprises:
diammonium hydrogen phosphate ((NH₄)₂HPO₄), and
ammonium sulphate ((NH₄)₂SO₄).

In some embodiments, component (a) (the phosphate, hydrogen phosphate or dihydrogen phosphate salt) consists of a hydrogen phosphate salt. In some embodiments, component (a) (the phosphate, hydrogen phosphate or dihydrogen phosphate salt) consists of diammonium hydrogen phosphate ((NH₄)₂HPO₄).

In some embodiments, component (b) (the hydrogen carbonate salt) consists of ammonium bicarbonate (NH₄HCO₃).

In some embodiments, component (c) (the sulphate salt) consists of ammonium sulphate ((NH₄)₂SO₄).

In some embodiments, the fire extinguishing liquid further comprises propylene glycol.

In some embodiments, the fire extinguishing liquid comprises:
(a) one or more of a phosphate, hydrogen phosphate or dihydrogen phosphate salt;
(b) a sulphate salt; and
(d) propylene glycol (C₃H₈O₂).

In this way, the fire extinguishing liquid is able to operate at lower temperatures without freezing due to the presence of propylene glycol in the composition. In some cases, the fire extinguishing liquid may be able to operate at temperatures as low as −20° C. without freezing. As such, the liquid may enable liquid-based fire extinguishers to operate in colder climates, as described above.

Herein, the terms “propylene glycol” and “monopropylene glycol” may be used interchangeably to refer to the compound:

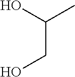

In some embodiments, the fire extinguishing liquid comprises:
diammonium hydrogen phosphate ((NH₄)₂HPO₄),
ammonium sulphate ((NH₄)₂SO₄) and
propylene glycol (C₃H₈O₂).

Preferably, the fire extinguishing liquid is an aqueous solution of the above mentioned components. In other words, the fire extinguishing liquid comprises:
(a) one or more of a phosphate, hydrogen phosphate or dihydrogen phosphate salt;
(b) a sulphate salt;
(d) optionally propylene glycol (C₃H₈O₂); and
(e) water.

It has been found that a fire extinguishing liquids of the present invention demonstrates better fire extinguishing results than known liquids. In preferred embodiments, the components set out above are dissolved in a solvent, preferably water, and more preferably demineralized water.

In order to better understand why the liquid displays these advantageous effects, the mechanism of combustion must first be understood namely the process of: heating→decomposition (or gasification)→ignition→combustion→extended chain of flame. Fire retardants or suppressants work by interfering with one or more of the steps in this mechanism. For example they may work by blocking the oxygen supply or forming an oxygen blockade layer; controlling the production of combustion gas; lowering the temperature of the combustibles, or generating incombustible gas and diluting combustible gas.

Examples of fire extinguishing mechanisms are as follows:
(i) Suffocation, in which gases generated by the heating of components in the fire extinguishing liquid (i.e. gas which is vaporized and generated by heat energy of the combustibles), e.g. ammonia, carbon dioxide, nitrogen, or water vapour, have a dilution effect on the combustible gas, and a suffocation effect due to oxygen blockade.
(ii) Endothermic effects, wherein the sublimation, vaporization, decomposition or heating of components within the fire extinguishing liquid (or combustion residues) leads to a temperature fall, as the heat energy released by the fire is expended in heating/vaporizing components of the liquid, rather than stoking the fire.
(iii) Restraining effects, in which the fire extinguishing liquid confines the combustibles, and has a fireproofing effect on said combustibles (i.e. forming a protective layer), both restraining the outbreak of gas and preventing the underlying material from igniting. Alternatively, the non-combustible solid combustion residues may provide the fireproofing effect.

Turning specifically to the components of the liquid of the present invention: without wishing to be bound by theory it is believed that when coming into contact with the heat of a fire, diammonium hydrogen phosphate decomposes according to: (NH₄)₂HPO₄→H₃PO₄+2NH₃, producing ammonia gas. The ammonia has a suffocating effect on the fire, by replacing the oxygen in the surroundings. It also helps to cool the combustibles by its heat of vaporization (see the endothermic effect above). Furthermore, chemical agents which are not vaporized stick to any combustibles, and in so doing make them non-combustible, by the restraining effect described above.

Similar to the diammonium hydrogen phosphate, without wishing to be bound by theory it is believed that when coming into contact with the heat of the fire, the ammonium hydrogen carbonate (if present) decomposes according to: NH₄HCO₃→NH₃+CO₂+H₂O. The ammonia has the same effects as for the diammonium hydrogen phosphate. In addition the CO₂ and H₂O also serve to have a suffocating effect on the flames. However it has been surprisingly found that in the absence of any hydrogen carbonate salt, the suffocating effect of the remaining components of the fire extinguishing liquid is not significantly affected, and in addition the liquid contains smaller quantities of salt per litre and is more straightforward to manufacture.

Further without wishing to be bound by theory it is believed that ammonium sulphate decomposes by pyrolysis according to (NH₄)₂SO₄→2NH₃+H₂SO₄, followed by the decomposition of the H₂SO₄ product into SO₃ and H₂O. Treating a source of combustion with (NH₄)₂SO₄ lowers the threshold temperature for pyrolysis and combustion and provides an increase in the residue or char production, which further contributes to retardancy.

When monopropylene glycol is present in the fire extinguishing liquid, this lowers the freezing point of the liquid. In doing so, it enables the liquid to be used in colder temperatures, specifically at temperature as low as −20° C. Furthermore, in contrast to other “anti-freezing” agents, monopropylene glycol is advantageous since it is both environmentally friendly and non-toxic. Being able to operate at lower temperatures is especially useful, for example, in cold countries where prior art fire extinguishing liquid would freeze, greatly reducing its effectiveness. Prior to now, it was necessary to use powder or CO₂ based extinguishers in such cold countries.

Preferably, at atmospheric pressure, the fire extinguishing liquid has a freezing point of at most 0° C., for example at most −5° C., at most −10° C., at most −15° C. or at most −20° C.

In some embodiments, the molar ratio in the fire extinguishing liquid of the phosphate, hydrogen phosphate or dihydrogen phosphate anion in (a), to the propylene glycol in (d), is from 0.3:1 to 0.8:1, preferably from 0.4:1 to 0.7:1.

In some embodiments, the fire extinguishing liquid also comprises water as a solvent, alongside the components mentioned above, such that the liquid is an aqueous solution of the specified components. In some embodiments, the molar ratio in the fire extinguishing liquid of the phosphate, hydrogen phosphate or dihydrogen phosphate anion in (a), to water, is from 0.01:1 to 0.5:1, preferably from 0.03:1 to 0.2:1, more preferably from 0.03:1 to 0.05:1. Such ratios of components have been found to lead to enhanced firefighting abilities of the fire extinguishing liquid.

In the following description, unless otherwise specified, percentages refer to weight percentages (wt %). By “weight percentage”, we mean the percentage by weight relative to the total weight of the liquid.

In some embodiments, the liquid comprises at least 10 wt % monopropylene glycol, for example at least 10.5 wt %, at least 11 wt %, at least 11.5 wt %, at least 12 wt %, at least 12.5 wt %, at least 13 wt %, at least 13.5 wt %, at least 14 wt %, at least 14.5 wt % or at least 15 wt %. In some embodiments, the liquid comprises up to 20 wt % ammonium sulphate, for example up to 19.5 wt %, up to 19 wt %, up to 18.5 wt %, up to 18 wt %, up to 17.5 wt % or up to 17 wt %.

In some embodiments, alongside the above components the liquid of the first aspect comprises solvent, preferably water, more preferably demineralised water. In some embodiments, the liquid of the first aspect comprises at least 30 wt % water, for example at least 35 wt %, at least 40 wt %, at least 45 wt %, at least 50 wt %, at least 60 wt % or at least 70 wt %. In some embodiments, the liquid comprises up to 80 wt % water, for example up to 75 wt %. In some embodiments, the liquid comprises 30 to 80 wt % water, for example 50 to 80 wt %, 60 to 80 wt %, 65 to 75 wt % or 70 to 75 wt %.

The fire extinguishing liquid may further include a firefighting foam component. Such a component both adds to the cooling effect of the liquid, and coats the combustible material, preventing oxygen contact and suppressing combustion. The foam component may include a surfactant, to lower the surface tension of the water in the foam. By lowering the surface tension, the water is able to better wet the surface of the combustible material, further reducing oxygen contact. In preferred embodiments, the firefighting foam component is a firefighting foam. In some embodiments, the firefighting foam component is an aqueous film forming foam (AFFF), such as FOMTEC® AFFF 3%. In some embodiments, the firefighting foam component is alcohol resistant aqueous film forming foam (AR-AFFF). The selection of firefighting foam component may depend on the particular intended application of the fire extinguishing liquid, as would be understood by the skilled person.

One example of a suitable AR-AFFF is Non-Newtonian 3×3% AR-AFFF manufactured by Aberdeen Foam.

In some embodiments, the firefighting foam component comprises diethylene glycol monobutyl ether, sulphuric acid mono-C6-C12-alkyl esters sodium salts, propan-1,2-diol, alkyl polyglycoside and ethylene oxide polymer.

In some embodiments, the firefighting foam component comprises 2-methylpentane-2-4-diol, sodium decyl sulphate and sodium octyl sulphate.

In some embodiments, the liquid contains at least 2% firefighting foam component, for example at least 2.5%, at least 3%, at least 3.5% or at least 4%

In some embodiments, the liquid contains up to 12% firefighting foam component, for example up to 11.5%, up to 11% or up to 10.5%.

In some embodiments, the liquid contains from 2 to 12 wt % firefighting foam component, for example from 2 to 10 wt %, from 2 to 8 wt %, from 2 to 6 wt % or from 4 to 5 wt %.

In some embodiments, the liquid contains at least 2% AR-AFFF, for example at least 2.5%, at least 3%, at least 3.5% or at least 4%

In some embodiments, the liquid contains up to 12% AR-AFFF, for example up to 11.5%, up to 11% or up to 10.5%.

In some embodiments, the liquid contains from 2 to 12 wt % AR-AFFF, for example from 2 to 10 wt %, from 2 to 8 wt %, from 2 to 6 wt % or from 4 to 5 wt %.

It has been found that liquids having compositions falling within the ranges set out above demonstrate improved fire extinguishing capabilities. For example, such liquids may provide reduced extinguishing time, reduced residual temperatures and/or a reduced quantity of liquid necessary to achieve extinguishment.

### First Aspect of the Invention

The following preferences apply to the first aspect of the invention.

The first aspect of the invention provides a fire extinguishing liquid comprising:
(a) one or more of a phosphate, hydrogen phosphate or dihydrogen phosphate salt; and
(b) a sulphate salt;
   wherein the fire extinguishing liquid contains no, or substantially no, hydrogen carbonate salts.

The fire extinguishing liquid of the first aspect contains no, or substantially no, hydrogen carbonate salts. Hydrogen carbonate salts are any salts including the anion HCO₃⁻. Thus the fire extinguishing liquid of the first aspect contains no, or substantially no, HCO₃⁻ anions. The term “substantially no hydrogen carbonate salts” means that hydrogen carbonate salts are present in an amount of less than 100 ppm (by weight), for example less than 50 ppm, less than 10 ppm or less than 5 ppm. Examples of such hydrogen carbonate salts are sodium hydrogen carbonate (NaHCO₃), potassium hydrogen carbonate (KHCO₃) and ammonium hydrogen carbonate ((NH₄)HCO₃).

In some embodiments, the molar ratio in the fire extinguishing liquid of the phosphate, hydrogen phosphate or dihydrogen phosphate anion in (a), to the sulphate anion in (b), is from 3:1 to 15:1, preferably from 4:1 to 10:1, more preferably from 6:1 to 10:1, or about 8:1.

Such ratios of components have been found to lead to enhanced firefighting abilities of the fire extinguishing liquid.

In the following description, unless otherwise specified, percentages refer to weight percentages (wt %). By “weight percentage”, we mean the percentage by weight relative to the total weight of the liquid.

In some embodiments, the liquid of the first aspect comprises at least 10 wt % phosphate, hydrogen phosphate or dihydrogen phosphate salt, for example at least 11 wt %, at least 12 wt %, at least 13 wt %, at least 14 wt %, at least 15 wt % or at least 16 wt %. In some embodiments, the liquid comprises up to 30 wt % phosphate, hydrogen phosphate or dihydrogen phosphate salt, for example up to 29 wt %, up to 28 wt %, up to 27 wt %, up to 26 wt %, up to 25 wt %, up to 24 wt %, up to 23 wt %, or up to 22 wt %. In some embodiments, the liquid comprises from 10 to 30 wt % phosphate, hydrogen phosphate or dihydrogen phosphate salt, for example from 15 to 25 wt %, from 18 to 22 wt % or from 20 to 22 wt %.

In some embodiments, the liquid of the first aspect comprises at least 10 wt % diammonium hydrogen phosphate, for example at least 11 wt %, at least 12 wt %, at least 13 wt %, at least 14 wt %, at least 15 wt % or at least 16 wt %. In some embodiments, the liquid comprises up to 30 wt % diammonium hydrogen phosphate, for example up to 29 wt %, up to 28 wt %, up to 27 wt %, up to 26 wt %, up to 25 wt %, up to 24 wt %, up to 23 wt %, or up to 22 wt %. In some embodiments, the liquid comprises from 10 to 30 wt % diammonium hydrogen phosphate, for example from 15 to 25 wt %, from 18 to 22 wt % or from 20 to 22 wt %.

In some embodiments, the liquid of the first aspect comprises at least 0.01 wt % sulphate salt, for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 1.0 wt %, at least 1.5 wt %, at least 2 wt % or at least 2.5 wt %. In some embodiments, the liquid comprises up to 10 wt % sulphate salt, for example up to 9 wt %, up to 8 wt %, up to 7 wt %, up to 6 wt %, up to 5 wt % or up to 4 wt %. In some embodiments, the liquid comprises 0.01 to 10 wt % sulphate salt, for example 0.1 to 10 wt %, 1 to 10 wt %, 1 to 5 wt % or 2 to 3 wt %.

In some embodiments, the liquid of the first aspect comprises at least 0.01 wt % ammonium sulphate, for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 1.0 wt %, at least 1.5 wt %, at least 2 wt % or at least 2.5 wt %. In some embodiments, the liquid comprises up to 10 wt % ammonium sulphate, for example up to 9 wt %, up to 8 wt %, up to 7 wt %, up to 6 wt %, up to 5 wt % or up to 4 wt %. In some embodiments, the liquid comprises 0.01 to 10 wt % ammonium sulphate, for example 0.1 to 10 wt %, 1 to 10 wt %, 1 to 5 wt % or 2 to 3 wt %.

In some embodiments, alongside the above components the liquid of the first aspect comprises solvent, preferably water, more preferably demineralised water. In some embodiments, the liquid of the first aspect comprises at least 30 wt % water, for example at least 35 wt %, at least 40 wt %, at least 45 wt %, at least 50 wt %, at least 60 wt % or at least 70 wt %. In some embodiments, the liquid comprises up to 80 wt % water, for example up to 75 wt %. In some embodiments, the liquid comprises 30 to 80 wt % water, for example 50 to 80 wt %, 60 to 80 wt % or 70 to 75 wt %.

In some embodiments, the liquid of the first aspect comprises or consists of
10 to 35 wt %, for example 15 to 25 wt % or 20 to 22 wt % diammonium hydrogen phosphate;
0.01 to 10 wt %, for example 2 to 8 wt %, 2 to 3 wt % or 2.5 to 3 wt % ammonium sulphate;
optionally 2 to 6 wt %, for example 3 to 5 wt % firefighting foam component; and
balance water, to provide a total of 100 wt %;
   wherein the fire extinguishing liquid contains no, or substantially no, hydrogen carbonate salts.

In some embodiments, the liquid of the first aspect comprises or consists of
10 to 35 wt %, for example 15 to 25 wt % or 20 to 22 wt % diammonium hydrogen phosphate;
0.01 to 10 wt %, for example 2 to 8 wt %, 2 to 3 wt % or 2.5 to 3 wt % ammonium sulphate;
optionally 2 to 6 wt %, for example 3 to 5 wt % firefighting foam component; and
65 to 75 wt %, for example 70 to 75 wt % water;
   wherein the amount of all components totals 100 wt %;
   wherein the fire extinguishing liquid contains no, or substantially no, hydrogen carbonate salts.

In some embodiments, the liquid of the first aspect comprises or consists of
20 to 22 wt % diammonium hydrogen phosphate;
2.5 to 3 wt % ammonium sulphate;
optionally 3 to 5 wt % firefighting foam component; and
balance water, to provide a total of 100 wt %;
   wherein the fire extinguishing liquid contains no, or substantially no, hydrogen carbonate salts.

In some embodiments, the liquid of the first aspect comprises or consists of
20 to 22 wt % diammonium hydrogen phosphate;
2.5 to 3 wt % ammonium sulphate;
optionally 3 to 5 wt % firefighting foam component; and
65 to 75 wt % water;
   wherein the amount of all components totals 100 wt %;
   wherein the fire extinguishing liquid contains no, or substantially no, hydrogen carbonate salts.

In some embodiments, the liquid of the first aspect consists of
15 to 25 wt % diammonium hydrogen phosphate;
2 to 8 wt % ammonium sulphate;
2 to 6 wt % AR-AFFF; and
balance water, to provide a total of 100 wt %;
   wherein the fire extinguishing liquid contains no, or substantially no, hydrogen carbonate salts.

In some embodiments, the liquid of the first aspect consists of
20 to 22 wt % diammonium hydrogen phosphate;
2.5 to 3 wt % ammonium sulphate;
3 to 5 wt % AR-AFFF; and
balance water, to provide a total of 100 wt %; 25
   wherein the fire extinguishing liquid contains no, or substantially no, hydrogen carbonate salts.
The liquid of the first aspect may contain 60% to 80% water, and more preferably 65% to 75% water, and more preferably still 70% to 75% water.
The liquid of the first aspect may contain 10% to 30% diammonium hydrogen phosphate, and more preferably 15% to 25% diammonium hydrogen phosphate, and more preferably still 20% to 22% diammonium hydrogen phosphate.
The liquid of the first aspect may contain 0.01% to 10% ammonium sulphate, and more preferably 1% to 5% ammonium sulphate, and more preferably still 2% to 3% or 2.5% to 3% ammonium sulphate.

In some embodiments, the weight ratio of diammonium hydrogen phosphate to ammonium sulphate in the extinguishing liquid of the first aspect is at least 2:1, for example at least 2.1:1, at least 2.2:1, at least 2.3:1, at least 2.4:1 or at least 2.5:1. In some embodiments, the weight ratio of diammonium hydrogen phosphate to ammonium sulphate in the extinguishing liquid of the first aspect is at least 3:1, for example at least 3.5:1, at least 4.0:1, at least 5:1, at least 6:1 or at least 7:1. In some embodiments, the weight ratio of diammonium hydrogen phosphate to ammonium sulphate in the extinguishing liquid of the first aspect is up to 10:1, for example up to 9:1 or up to 8:1.

In some embodiments, the weight ratio of diammonium hydrogen phosphate to ammonium sulphate in the extinguishing liquid of the first aspect is from 2:1 to 10:1, for example from 5:1 to 10:1 or from 7.5:1 to 8.5:1.

### Second Aspect of the Invention

The following preferences apply to the second aspect of the invention.

The second aspect of the invention is a fire extinguishing liquid comprising:
(a) one or more of a phosphate, hydrogen phosphate or dihydrogen phosphate salt, wherein the total amount of phosphate, hydrogen phosphate and dihydrogen phosphate saltis from 20 to 25 wt %, based on the total weight of the fire extinguishing liquid; and
(b) a sulphate salt, wherein the total amount of sulphate salt is from 2 to 3 wt %, based on the total weight of the fire extinguishing liquid.

In some embodiments, the fire extinguishing liquid of the second aspect contains no, or substantially no, hydrogen carbonate salts. In other embodiments, the fire extinguishing liquid of the second aspect comprises one or more hydrogen carbonate salts. In some embodiments, the hydrogen carbonate salts are selected from sodium hydrogen carbonate (NaHCO₃), potassium hydrogen carbonate (KHCO₃) and ammonium hydrogen carbonate ((NH₄)HCO₃). In some embodiments, the hydrogen carbonate salt is ammonium hydrogen carbonate ((NH₄)HCO₃).

In some embodiments, the molar ratio in the fire extinguishing liquid of the phosphate, hydrogen phosphate or dihydrogen phosphate anion in (a), to the sulphate anion in (b), is from 3:1 to 15:1, preferably from 4:1 to 10:1, more preferably from 6:1 to 10:1, or about 8:1.

Such ratios of components have been found to lead to enhanced firefighting abilities of the fire extinguishing liquid.

In the following description, unless otherwise specified, percentages refer to weight percentages (wt %). By “weight percentage”, we mean the percentage by weight relative to the total weight of the liquid.

In some embodiments, the liquid of the second aspect comprises at least 20.1 wt % phosphate, hydrogen phosphate or dihydrogen phosphate salt, for example at least 20.2 wt %, at least 20.3 wt %, at least 20.4 wt %, at least 20.5 wt %, at least 20.6 wt % or at least 20.7 wt %. In some embodiments, the liquid comprises up to 24.5 wt % phosphate, hydrogen phosphate or dihydrogen phosphate salt, for example up to 24 wt %, up to 23.5 wt %, up to 23 wt %, up to 22.5 wt %, up to 22 wt %, up to 21.5 wt %, up to 21.4 wt %, or up to 21.3 wt %. In some embodiments, the liquid comprises from 20 to 22 wt % phosphate, hydrogen phosphate or dihydrogen phosphate salt, for example from 20.5 to 21.5 wt % or from 21.0 to 21.4 wt %.

In some embodiments, the liquid of the second aspect comprises at least 20.1 wt % diammonium hydrogen phosphate, for example at least 20.2 wt %, at least 20.3 wt %, at least 20.4 wt %, at least 20.5 wt %, at least 20.6 wt % or at least 20.7 wt %. In some embodiments, the liquid comprises up to 24.5 wt % diammonium hydrogen phosphate, for example up to 24 wt %, up to 23.5 wt %, up to 23 wt %, up to 22.5 wt %, up to 22 wt %, up to 21.5 wt %, up to 21.4 wt %, or up to 21.3 wt %. In some embodiments, the liquid comprises from 20 to 22 wt % diammonium hydrogen phosphate, for example from 20.5 to 21.5 wt % or from 21.0 to 21.4 wt %.

In some embodiments, the liquid of the second aspect comprises at least 2.1 wt % sulphate salt, for example at least 2.2 wt %, at least 2.3 wt %, at least 2.4 wt %, at least 2.5 wt %, at least 2.6 wt % or at least 2.65 wt %. In some embodiments, the liquid comprises up to 2.9 wt % sulphate salt, for example up to 2.85 wt %, up to 2.8 wt % or up to 2.75 wt %. In some embodiments, the liquid comprises 2.1 to 2.9 wt % sulphate salt, for example 2.5 to 2.9 wt %, 2.6 to 2.8 wt % or about 2.7 wt %.

In some embodiments, the liquid of the second aspect comprises at least 2.1 wt % ammonium sulphate, for example at least 2.2 wt %, at least 2.3 wt %, at least 2.4 wt %, at least 2.5 wt %, at least 2.6 wt % or at least 2.65 wt %. In some embodiments, the liquid comprises up to 2.9 wt % ammonium sulphate, for example up to 2.85 wt %, up to 2.8 wt % or up to 2.75 wt %. In some embodiments, the liquid comprises 2.1 to 2.9 wt % ammonium sulphate, for example 2.5 to 2.9 wt %, 2.6 to 2.8 wt % or about 2.7 wt %.

In some embodiments, alongside the above components the liquid of the second aspect comprises solvent, preferably water, more preferably demineralised water. In some embodiments, the liquid of the second aspect comprises at least 30 wt % water, for example at least 35 wt %, at least 40 wt %, at least 45 wt %, at least 50 wt %, at least 60 wt % or at least 70 wt %. In some embodiments, the liquid comprises up to 80 wt % water, for example up to 75 wt %. In some embodiments, the liquid comprises 30 to 80 wt % water, for example 50 to 80 wt %, 60 to 80 wt % or 70 to 75 wt %.

In some embodiments, the fire extinguishing liquid of the second aspect comprises: diammonium hydrogen phosphate ((NH₄)₂HPO₄), wherein the total amount of phosphate, hydrogen phosphate and dihydrogen phosphate salt is from 20 to 25 wt %, based on the total weight of the fire extinguishing liquid; and ammonium sulphate ((NH₄)₂SO₄), wherein the total amount of phosphate, hydrogen phosphate and dihydrogen phosphate salt is from 2 to 3 wt %, based on the total weight of the fire extinguishing liquid.

In some embodiments, the liquid of the second aspect comprises or consists of
20 to 25 wt %, for example 20 to 24 wt % or 20 to 22 wt % diammonium hydrogen phosphate;
2 to 3 wt %, for example 2.2 to 3 wt %, 2.5 to 3 wt % or 2.6 to 2.8 wt % ammonium sulphate;
optionally 2 to 6 wt %, for example 3 to 5 wt % firefighting foam component; and
balance water, to provide a total of 100 wt %.

In some embodiments, the liquid of the second aspect comprises or consists of
20 to 25 wt %, for example 20 to 24 wt % or 20 to 22 wt % diammonium hydrogen phosphate;
2 to 3 wt %, for example 2.2 to 3 wt %, 2.5 to 3 wt % or 2.6 to 2.8 wt % ammonium sulphate;
optionally 2 to 6 wt %, for example 3 to 5 wt % firefighting foam component; and
65 to 75 wt % water;
   wherein the amount of all components totals 100 wt %.

In some embodiments, the liquid of the second aspect comprises or consists of
20 to 22 wt % diammonium hydrogen phosphate;
2.5 to 3 wt % ammonium sulphate;
optionally 3 to 5 wt % firefighting foam component; and
balance water, to provide a total of 100 wt %.

In some embodiments, the liquid of the second aspect comprises or consists of
20 to 22 wt % diammonium hydrogen phosphate;
2.5 to 3 wt % ammonium sulphate;
optionally 3 to 5 wt % firefighting foam component; and
65 to 75 wt % water;
   wherein the amount of all components totals 100 wt %.
The liquid of the second aspect may contain 60% to 80% water, and more preferably 65% to 75% water, and more preferably still 70% to 75% water.
The liquid of the second aspect may contain 20% to 25% diammonium hydrogen phosphate, and more preferably 20% to 24% diammonium hydrogen phosphate, and more preferably still 20% to 22% diammonium hydrogen phosphate.
The liquid of the second aspect may contain 2% to 3% ammonium sulphate, and more preferably 2.5% to 3% ammonium sulphate, and more preferably still 2.6% to 2.8% ammonium sulphate.

In some embodiments, the weight ratio of diammonium hydrogen phosphate to ammonium sulphate in the extinguishing liquid of the second aspect is at least 2:1, for example at least 2.1:1, at least 2.2:1, at least 2.3:1, at least 2.4:1 or at least 2.5:1. In some embodiments, the weight ratio of diammonium hydrogen phosphate to ammonium sulphate in the extinguishing liquid of the second aspect is at least 3:1, for example at least 3.5:1, at least 4.0:1, at least 5:1, at least 6:1 or at least 7:1. In some embodiments, the weight ratio of diammonium hydrogen phosphate to ammonium sulphate in the extinguishing liquid of the second aspect is up to 10:1, for example up to 9:1 or up to 8:1.

In some embodiments, the weight ratio of diammonium hydrogen phosphate to ammonium sulphate in the extinguishing liquid of the second aspect is from 2:1 to 10:1, for example from 5:1 to 10:1 or from 7.5:1 to 8.5:1.

A third aspect of the invention is a method of manufacturing a fire extinguishing liquid according to either the first or second aspect comprising the step of mixing (a) one or more of a phosphate, hydrogen phosphate or dihydrogen phosphate salt; (b) a sulphate salt; and a liquid vehicle. In some embodiments, the liquid vehicle is water, preferably demineralised water.

In some embodiments, the method comprises the step of mixing diammonium hydrogen phosphate ((NH₄)₂HPO₄), ammonium sulphate ((NH₄)₂SO₄) and a liquid vehicle. In some embodiments, the liquid vehicle is water, preferably demineralised water.

In some embodiments, the method further comprises mixing propylene glycol (C₃H₈O₂) with the diammonium hydrogen phosphate ((NH₄)₂HPO₄), ammonium sulphate ((NH₄)₂SO₄) and liquid vehicle.

In some embodiments, the method of manufacturing the fire extinguishing liquid comprises the steps of:
(A) heating water to a temperature above room temperature; and
(B) adding diammonium hydrogen phosphate ((NH₄)₂HPO₄) and ammonium sulphate ((NH₄)₂SO₄) to the water.

In some embodiments the method further comprises adding propylene glycol (C₃H₈O₂) to the water in step (B).

In some embodiments, the method further comprises the addition of the firefighting foam component described above.

In some embodiments, the method comprises mixing the solution after the addition of one or more of diammonium hydrogen phosphate ((NH₄)₂HPO₄), ammonium sulphate ((NH₄)₂SO₄) and propylene glycol (C₃H₈O₂). In some embodiments, after step (B) the method includes an additional step (C) of cooling the solution to below 25° C.

In some embodiments, after step (C) the method includes an additional step (D) of filtering the solution to remove undissolved residue. This filtering step may be carried out using any well-known filtration technique, including but not limited to passing the solution through filter paper or a sieve.

‘Room temperature’ refers to a temperature of around 21° C.

In some embodiments, the water is first heated in step (A) to a temperature in the range 30 to 70° C. before any of the other components are added. This leads to improved dissolution of the other components of the composition. In some embodiments, the heating is carried out using an immersion heater, such as an electric element within the mixing tank. Other suitable methods of heating the water are known to the skilled person.

In some embodiments, each of diammonium hydrogen phosphate ((NH₄)₂HPO₄), ammonium sulphate ((NH₄)₂SO₄) and optionally propylene glycol (C₃H₈O₂) are added to the water separately. In some embodiments, diammonium hydrogen phosphate ((NH₄)₂HPO₄) is added to the water in a first step, followed by the remaining components. In some embodiments, propylene glycol (C₃H₈O₂) is added after each of diammonium hydrogen phosphate ((NH₄)₂HPO₄) and ammonium sulphate ((NH₄)₂SO₄) have been added.

In some embodiments, the method of manufacturing the fire extinguishing liquid comprises the steps of:
(i) heating water to a temperature above room temperature, preferably to a temperature in the range 30 to 70° C.;
(ii) adding diammonium hydrogen phosphate and mixing until dissolved;
(iii) adding ammonium sulphate and mixing until dissolved; and
(iv) optionally adding one or more of monopropylene glycol and firefighting foam component, and mixing until dissolved.

In some embodiments, after optional step (iv) the method includes an additional step (v) of cooling the solution of water, diammonium hydrogen phosphate and ammonium sulphate to below 25° C.

In some embodiments, after step (v) the method includes an additional step (vi) of filtering the solution to remove undissolved residue. This filtering step may be carried out using any well-known filtration technique, including but not limited to passing the solution through filter paper or a sieve.

The amount of each component added to the water is preferably selected to arrive at a composition having:
60% to 80% of water, and more preferably 65% to 75% of water, and more preferably still 70% to 75% of water.
10% to 30% diammonium hydrogen phosphate, and more preferably 15% to 25% diammonium hydrogen phosphate, and more preferably still 20% to 22% diammonium hydrogen phosphate.
0.01% to 10% ammonium sulphate, and more preferably 1% to 5% ammonium sulphate, and more preferably still 2% to 3% ammonium sulphate.
when present, 10% to 20% monopropylene glycol, and more preferably 12.5% to 17.5% monopropylene glycol, and more preferably still 15% to 17% monopropylene glycol.
when present, from 2 to 12 wt % firefighting foam component, for example from 2 to 10 wt %, from 2 to 8 wt %, from 2 to 6 wt % or from 4 to 5 wt %.

In steps (ii) and (iii), the components are preferably added to the mixture in their natural physical form, that is in solid form, preferably in the form of grains or a powder. Throughout these steps the diammonium hydrogen phosphate, ammonium bicarbonate and the ammonium sulphate are preferably added while the mixture is being mixed or stirred. In optional step (iv) the monopropylene glycol is preferably added in its natural physical form, namely in liquid form.

The method may further include a step of adding a firefighting foam component as described earlier in the application. As above, the weight of firefighting foam component is preferably selected to arrive at an overall composition having 2% to 6%, for example 3% to 5% of firefighting foam component.

By heating the water first, in step (i), the dissolution of the components in steps (ii) to (iv) is improved. In preferred embodiments, the addition of the diammonium hydrogen phosphate is carried out in small increments. In this way, the chance of a rapid reduction in the temperature of the water is prevented, which may otherwise lead to a reduction in solubility. Specifically, in preferred embodiments, after a small amount of diammonium hydrogen phosphate is added to the water, that small amount should dissolve fully before a second small amount is added. In some embodiments, the total amount of diammonium hydrogen phosphate is added to the liquid vehicle in two or more batches, for example three, four or five batches, allowing for full dissolution, preferably with mixing, after each batch addition. In some embodiments, after all of the diammonium hydrogen phosphate is added, the mixture is mixed or stirred for 10 to 30 minutes to ensure an even distribution of the diammonium hydrogen phosphate throughout the mixture. Furthermore, throughout the addition steps (ii) and (iii), it is preferable that the water is maintained at a temperature from 30° C. to 70° C., in order to aid the dissolution of the diammonium hydrogen phosphate and ammonium sulphate in steps (ii) and (iii) respectively.

After step (iii), the mixture may be mixed or stirred for 5 to 20 minutes, again to ensure uniform distribution of the ammonium sulphate throughout the mixture. More preferably, the mixture is mixed or stirred for about 10 minutes.

In step (v), it is preferable that the water is cooled to below 25° C., for example below 24° C., below 23° C., below 22° C., below 21° C. or below 20° C. In some embodiments, the solution is left to cool naturally for a period of at least 5 hours, such as at least 6 hours, at least 7 hours or at least 8 hours. By cooling the mixture to a temperature which is approximately room temperature, the capacity of the water to hold the diammonium hydrogen phosphate, and ammonium sulphate in solution is decreased. As a result, a portion of any or all of these components may precipitate out of solution. Clearly, it is undesirable that this happens when the liquid has been packaged in e.g. a fire extinguisher. For example, such precipitation may cause the solid grains to block the extinguisher nozzle or any valves within extinguishers or aerosols, which risks reducing its effectiveness, or even rendering the fire extinguisher completely inoperable. So, the combination of the cooling in step (v) and the filtering in step (vi), which removes any diammonium hydrogen phosphate and ammonium sulphate which may have precipitated as a result of cooling, and also any undissolved residues or impurities, ensures that the liquid does not contain any solid particulate matter which could block or damage a fire extinguisher in which the liquid may be contained.

The filtering may be performed using a mesh, the mesh size (i.e. the average size of the holes in the mesh) of which, is preferably selected to catch (i.e. filter out) particles whose dimensions are such that they risk damaging or blocking a fire extinguisher. For example, the mesh size may be 0.5 mm or less. More preferably the mesh size is 0.1 mm or less, and more preferably still, the mesh size is 0.05 mm or less.

The method may include a further step of filling a fire extinguisher with the liquid. Step (vi), the filtering step, may take place as the fire extinguisher is being filled, in order to minimize the number of steps in the manufacturing process.

A fourth aspect of the present invention provides a fire extinguisher (i.e., a fire extinguishing device) containing the liquid according to the first or second aspect of the present invention. The liquid may include any of the optional features which have been set out above with respect to the first, second and third aspects of the invention, where compatible.

A variety of fire extinguishing devices may be used to contain and deliver the fire extinguishing liquid according to the invention. For example, self-contained hand-held pressurised extinguishers may be used, wherein the liquid is delivered through a nozzle. The liquid may also be added to a sealed sachet, which could find use for example in fighting pan fires in a domestic environment. More sophisticated fire-fighting systems could also employ the fire extinguishing liquid of the invention, for example hose reel jets, high pressure hose reel jets, compressed air foam systems and ultra high pressure lance systems. Such systems are more suited for use by professional fire-fighters, such as fire and rescue service crew.

The liquid may be used in its concentrated form according to a composition as described herein, or may be diluted further with a liquid vehicle such as water. For example, the liquid may be diluted with water to provide a weight ratio of extinguishing liquid:water in the range of from 4:96 to 50:50, preferably from 6:94 to 30:70.

A further aspect of the invention is the use of the fire extinguishing liquid according to the first or second aspect to extinguish a fire, for example a battery fire such as a lithium-ion battery fire.

### EXAMPLES

### Example 1

A fire extinguishing liquid was prepared according to the following method:
1) demineralized water was run into a mixing vessel, and heated to 40° C. using an electric element located within the mixing vessel.
2) diammonium hydrogen phosphate was added slowly to the demineralized water in batches, allowing each batch to dissolve before making another addition. Thereafter, the solution was mixed for 15 to 20 minutes until the last of the diammonium hydrogen phosphate was dissolved. 25
3) ammonium sulphate was added while mixing. After all of the ammonium sulphate was dissolved, the solution was mixed for a further 30 minutes.
5) AR-AFFF was added (Non-Newtonian 3×3% AR-AFFF manufactured by Aberdeen Foam), while slowly mixing (to avoid foaming). The mixture was allowed to cool to below 25° C., and was then passed through a 20 μm filter and the filtrate was passed directly into a fire extinguisher vessel.

The quantities of each ingredient were measured so that the amounts of each component in the final composition fell within the following ranges, based on the total weight of the overall composition: 20 to 22 wt % diammonium hydrogen phosphate; 3 to 5 wt % AR-AFFF; 2.6 to 2.8 wt % ammonium sulphate; and 65 to 75 wt % deionised/demineralised water.

A 6-litre steel Commander Edge Extinguisher was filled with the liquid and nitrogen gas was added as propellant. The extinguisher included a foam rose nozzle. The extinguisher was used on a range of fire types and the results are provided in Table 1 below.

TABLE 1

| | Time until complete |
|---|---|
| Fire type | extinguishment |
| Two 14.8 V laptop batteries | <5 seconds |
| Six 14.8 V laptop batteries | <10 seconds |
| 36 V e-scooter battery | <5 seconds |
| 12 L diesel | <5 seconds |
| 3 L petrol | <5 seconds |
| 2 L bioethanol | <5 seconds |

The results show that the liquid is able to effectively extinguish a range of different fire types, including battery fires, despite the lack of any hydrogen carbonate salt.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A fire extinguishing liquid comprising:
(a) one or more of a phosphate, hydrogen phosphate or dihydrogen phosphate salt; and
(b) a sulphate salt;
wherein the fire extinguishing liquid contains no, or substantially no, hydrogen carbonate salts.

2. A fire extinguishing liquid according to claim 1, wherein the salts are all dissolved in a liquid vehicle.

3. A fire extinguishing liquid according to claim 2, wherein the liquid vehicle is water.

4. A fire extinguishing liquid according to claim 3, wherein the water is demineralized water.

5. A fire extinguishing liquid according to claim 4, wherein the fire extinguishing liquid comprises 65% to 75% water by weight.

6. A fire extinguishing liquid according to any one of claims 3 to 5, wherein the molar ratio in the fire extinguishing liquid of the phosphate, hydrogen phosphate or dihydrogen phosphate anion in (a), to water, is from 0.01:1 to 0.5:1.

7. A fire extinguishing liquid according to any one of claims 1 to 6, wherein the molar ratio in the fire extinguishing liquid of the phosphate, hydrogen phosphate or dihydrogen phosphate anion in (a), to the sulphate anion in (b), is from 3:1 to 15:1.

8. A fire extinguishing liquid according to any one of claims 1 to 7, wherein the one or more of a phosphate, hydrogen phosphate or dihydrogen phosphate salt comprises or consists of diammonium hydrogen phosphate ((NH₄)₂HPO₄).

9. A fire extinguishing liquid according to claim 8, wherein the fire extinguishing liquid comprises 15% to 25% diammonium hydrogen phosphate by weight.

10. A fire extinguishing liquid according to any one of claims 1 to 9, wherein the sulphate salt comprises or consists of ammonium sulphate ((NH₄)₂SO₄).

11. A fire extinguishing liquid according to claim 10, wherein the fire extinguishing liquid comprises 2% to 3% ammonium sulphate by weight.

12. A fire extinguishing liquid according to claim 11, wherein the weight ratio of diammonium hydrogen phosphate to ammonium sulphate in the extinguishing liquid is at least 2:1, preferably at least 3:1.

13. A fire extinguishing liquid according to any one of claims 1 to 12, further including a firefighting foam component.

14. A fire extinguishing liquid according to claim 13, wherein the firefighting foam component includes a surfactant.

15. A fire extinguishing liquid according to claim 14, wherein the firefighting foam component is an alcohol-resistant aqueous film forming foam (AR-AFFF).

16. A fire extinguishing liquid according to any one of claims 13 to 15, wherein the fire extinguishing liquid comprises 4% to 5% firefighting foam component by weight.

17. A fire extinguishing liquid according to any one of claims 1 to 16, wherein the fire extinguishing liquid contains no hydrogen carbonate salts, or contains hydrogen carbonate salts in an amount of less than 100 ppm by weight, based on the total weight of the fire extinguishing liquid.

18. A fire extinguishing liquid comprising:
(a) one or more of a phosphate, hydrogen phosphate or dihydrogen phosphate salt, wherein the total amount of phosphate, hydrogen phosphate and dihydrogen phosphate salt is from 20 to 25 wt %, based on the total weight of the fire extinguishing liquid; and
(b) a sulphate salt, wherein the total amount of sulphate salt is from 2 to 3 wt %, based on the total weight of the fire extinguishing liquid.

19. A fire extinguishing liquid according to claim 18, wherein the fire extinguishing liquid contains no, or substantially no, hydrogen carbonate salts.

20. A fire extinguishing liquid according to claim 18 or 19, wherein the fire extinguishing liquid comprises 20 to 22 wt % phosphate, hydrogen phosphate or dihydrogen phosphate salt.

21. A fire extinguishing liquid according to any one of claims 18 to 20, wherein the fire extinguishing liquid comprises 2.6 to 2.8 wt % sulphate salt.

22. A method of manufacturing a fire extinguishing liquid according to any one of claims 1 to 21 comprising the step of mixing (a) one or more of a phosphate, hydrogen phosphate or dihydrogen phosphate salt; (b) a sulphate salt; and a liquid vehicle.

23. A method according to claim 22, wherein component (a) is diammonium hydrogen phosphate ((NH₄)₂HPO₄), and component (b) is ammonium sulphate ((NH₄)₂SO₄).

24. A method according to claim 22 or 23, wherein the liquid vehicle is water.

25. A method according to any one of claims 22 to 24, the method comprising the steps of:
(i) heating water to 30° C. to 70° C.;
(ii) adding diammonium hydrogen phosphate and mixing until dissolved; and
(iii) adding ammonium sulphate and mixing until dissolved.

26. A method according to claim 25, further comprising the steps:
(iv) cooling the mixture of water, diammonium hydrogen phosphate and ammonium sulphate to below 25° C.; and
(v) filtering to remove undissolved residue.

27. A method according to any one of claims 22 to 26, wherein the phosphate, hydrogen phosphate or dihydrogen phosphate salt, and sulphate salt are added in solid form.

28. A method according to any one of claims 22 to 27, further including the step of adding a firefighting foam component.

29. A method according to any one of claims 22 to 28, further including the step of filling a fire extinguisher with the fire extinguishing liquid.

30. A method according to claim 29, wherein the filtering step is performed as the fire extinguisher is being filled.

31. A fire extinguishing liquid made by a method according to any one of claims 22 to 30.

32. A fire extinguisher containing the fire extinguishing liquid of any one of claims 1 to 21.

33. A method of extinguishing a fire using a fire extinguishing liquid of any one of claims 1 to 21.
